(19) United States
(12) Patent Application Publication
(10) Pub. No.: US 2015/0269029 A1
(43) Pub. Date: Sep. 24, 2015

(54) Immediate Recovery of an Application from File Based Backups

(71) Applicants: Kenneth A. Smith, Lexington, SC (US); Sameer Kamat, Columbia, SC (US); Elizabeth Campbell, Lexington, SC (US); Vernon Keith Boland, Lexington, SC (US)

(72) Inventors: Kenneth A. Smith, Lexington, SC (US); Sameer Kamat, Columbia, SC (US); Elizabeth Campbell, Lexington, SC (US); Vernon Keith Boland, Lexington, SC (US)

(73) Assignee: UNITRENDS, INC., Columbia, SC (US)

(21) Appl. No.: 14/317,722

(22) Filed: Jun. 27, 2014

Related U.S. Application Data
(60) Provisional application No. 61/968,164, filed on Mar. 20, 2014.

(51) Int. Cl. G06F 11/14; G06F 9/44

(52) U.S. Cl. CPC G06F 11/1435; G06F 9/4416; G06F 9/4406; G06F 11/1417; G06F 11/1451; G06F 11/1484; G06F 2201/84; G06F 2201/815

(57) ABSTRACT

A method and apparatus is provided for the backup and immediate recovery of an application executing on a computer. The method and apparatus provides file level backup of a target computer executing the application. The file level backup is transformed into a bootable machine image that is accessible for immediate recovery of the application by either a virtual server executing on the apparatus or an external server or an external virtual server.

### CROSS REFERENCE TO RELATED APPLICATION

The present application claims the benefit of U.S. Provisional Application Ser. No. 61/968,164 entitled “Immediate Recovery of an Application from File Based Backups” and filed Mar. 20, 2014 which is incorporated herein by reference in its entirety.

### FIELD OF THE INVENTION

The present invention relates generally to disaster recovery of computer platforms and more specifically to backing up and restoring an application using file based backups.

### BACKGROUND

It is common to implement some level of disaster recovery for a computer or computer system. A disaster recovery plan includes one or more techniques for backing up part or all of the data, software, and information required to operate a computer or a computer system. Typically, the more critical the application executed by the computer, the higher the level of disaster recovery implemented by the computer.

Computer backup systems may suitably provide functionality to backup and restore individual server computers, both at the physical and virtual level, to provide the ability to recover the server in the event of a disaster that renders the server unusable. These backups are often referred to as bare-metal backups because a new server can be restored from a blank or “bare metal” state back to the state of the original server including its operating system and applications. This is sometimes referred to as immediate recovery because during the recovery process an entire disk image is written to a disk. Once the disk image is stored, a server computer can boot from the disk. Another method of backing up and recovering a server is known as a file level application backup. With this method, an initial full backup is made and then incremental updates of files are made as files are updated or created in the server being backed up. This reduces the backup time because files that have not changed are not updated after the first update. It takes longer to recover a server using a file level application backup than when using a bare-metal backup, however during the backup phase, the bare-metal backup requires more computer resources than the file level application backup.

### SUMMARY

Among its several aspects, the present invention seeks to overcome or ameliorate at least one of the disadvantages of the prior art, or to provide a useful alternative.

In accordance with the teachings of the present invention, a backup and restore method and computer is provided for backing up and immediate restoring an application executing on another computer. The invention maintains a virtual machine image that includes the application and in some embodiments the operating system. The virtual machine image is created and maintained using a file backup method where individual files are received from the other computer executing the application. Should the other computer fail or the application it is executing is not available to perform its function, a virtual server can immediately boot up using the virtual machine image and execute the application. The invention maintains the virtual machine image in a ready state updated with the most recently received files. In this state, the virtual machine image is immediately available to recover the application by allowing a virtual server to boot from the virtual machine image.

Among its several aspects, the present invention recognizes there is an advantage to performing an incremental file backup of a computer executing an application and continuously transforming the file based backup to a bootable virtual machine image of the computer that can be immediately executed to recover the application.

Among its several aspects, the present invention recognizes there is an advantage to having a bootable virtual machine image that can be accessed immediately by a virtual server executing on either the backup computer or an external computer executing a virtual server.

In accordance with an embodiment of the present invention, there is provided a computer implemented method performed by a backup computer for backing up and restoring an application executing on another computer to immediately recover the application. The method comprising: creating a virtual machine image for the application where the virtual machine image can be immediately accessed to implement a recovery of the application; receiving files from a computer system executing the application; transforming the received files to the virtual machine image format; and updating the virtual machine image with the transformed received files.

In accordance with another embodiment of the present invention, there is provided a backup computer. The backup computer comprising: a memory including computer instructions that implement the functions of the backup computer when executed; and a processor in communication with the memory where when the processor executes the computer instructions they cause the processor to perform the following steps: creating a virtual machine image for the application where the virtual machine image can be immediately accessed to implement a recovery of the application; receiving files from a computer system executing the application; transforming the received files to the virtual machine image format; and updating the virtual machine image with the transformed received files.

In accordance with another embodiment of the present invention, there is provided one or more non-transitory digital storage media storing instructions which, when executed by one or more computing devices, causes performance of the method recited in Claim 1.

A more complete understanding of the present invention, as well as further features and advantages of the invention, will be apparent from the following Detailed Description and the accompanying Drawings.

### BRIEF DESCRIPTION OF THE DRAWINGS

The present invention may take form in various components and arrangement of components and in various methods. The drawings are only for purposes of illustrating example embodiments and alternatives and are not to be construed as limiting the invention. The drawings are not necessarily drawn to scale. Throughout the drawings, like element numbers are used to describe the same parts throughout the various drawings, figures and charts.

FIG. 1 is a high-level block diagram of an exemplary computer system of one embodiment of the present invention for immediate recovery of a file level application backup.

FIG. 2 is a high-level block diagram of an exemplary system of another embodiment of the present invention for immediate recovery of a file level application backup that has been replicated over a network and which will be restored to a pre-installed operating system on a virtual machine.

FIG. 3 is a high-level flowchart illustrating a method of immediate recovery of a file level application backup with options for recovery of either the original operating system or a different operating system compatible with the application.

### DETAILED DESCRIPTION

In the following description, numerous details are set forth to provide an understanding of the claimed invention. However, it will be understood by those skilled in the art that aspects of the claimed invention may be practiced without utilizing all of these details and that numerous variations or modifications from the described embodiments are possible and envisioned.

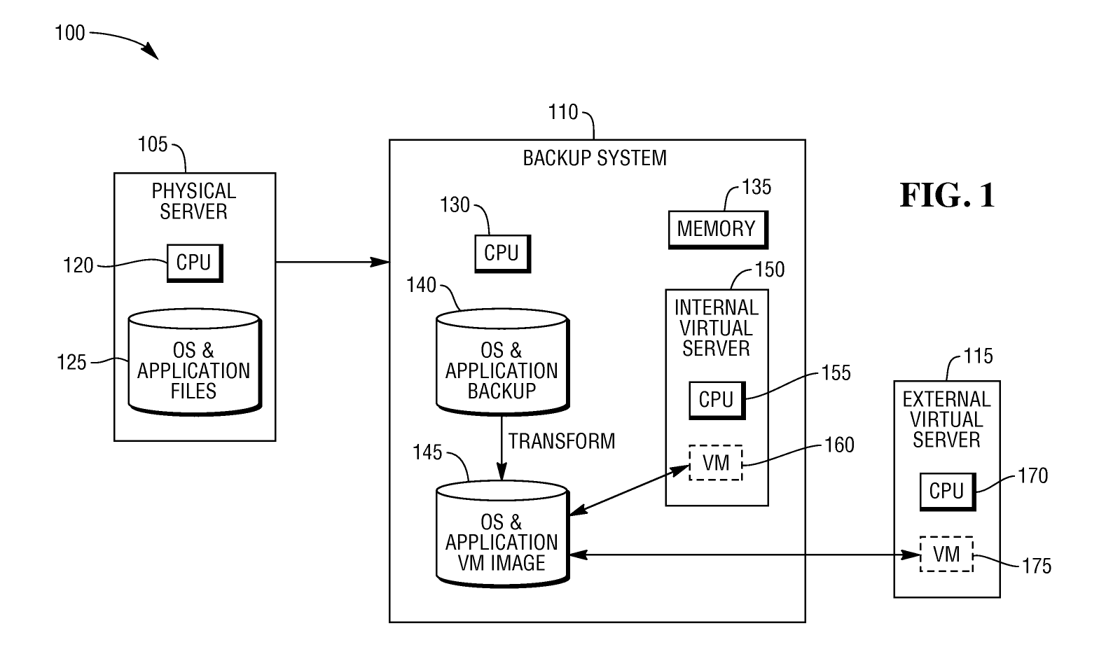

With reference to FIG. 1, there is provided a high-level block diagram of an exemplary computer system 100 of one embodiment of the present invention for immediate recovery of a file level application backup. The computer system 100 includes a backup system 110 in communication with a physical server 105 and an external virtual server 115.

The backup system 110 includes a CPU 130 in communication with: a memory 135, a first storage device 140, a second storage device 145 and an internal virtual server 150. The first and second storage devices 140, 145 may suitably include multiple non-volatile storage devices such as disk drives or solid state drives or a combination thereof. The CPU 130 executes software that is stored in the memory 135 which causes the CPU 130 to perform the functions of the backup system 110. The CPU 130 causes OS & application backup data received from the physical server 105 to be transformed into an OS & Application VM Image stored on the second storage device 145. The internal virtual server 150 includes a CPU 155 which executes software to create a virtual machine (VM) 160. The CPU 130 may suitably cause an OS & Application VM Image stored on the second storage device 145 to be loaded into the VM 160 and executed by the internal virtual server 150. The CPU 130 may suitably cause an OS & Application VM Image stored on the second storage device 145 to be loaded into a virtual machine (VM) 175 of the external virtual server 115. A CPU 170 in the external virtual server 115 implements the VM 175.

The physical server 105 includes a central processing unit (CPU) 120 that executes one or more applications and an operating system all residing on a storage device 125. The storage device 125 may suitably include multiple non-volatile storage devices such as disk drives or solid state drives or a combination thereof. The backup system 110 initiates a file-based (non-image based) backup of the physical server 105 at a specific point in time. The backup will either comprise only the files associated with the application, or all files on the server, including both the application and the operating system. These files are received by the backup system 110 and converted to a backup format and stored on the first storage device 140.

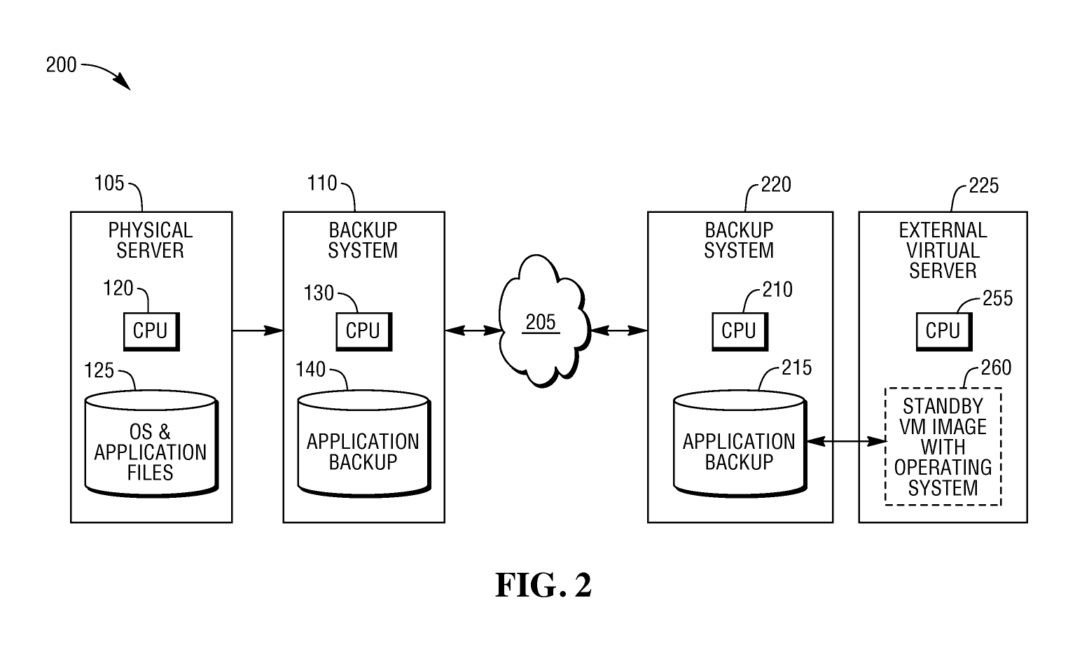

Turning now to FIG. 2, there is provided a high-level block diagram of an exemplary system of another embodiment of the present invention for immediate recovery of a file level application backup that has been replicated over a network and which will be restored to a pre-installed operating system on a virtual machine. In this embodiment, application files reside and execute on the physical server 105 and are backed up to the backup system 110. The backup system 110 communicates over a network 205 to a remote backup system 220 which is in communication with an external virtual server 225. The network 205 may suitably include combinations of private and public networks where one of the public networks is the Internet.

The embodiment provides the ability to perform an immediate recovery of the application on an external virtual server 225 remotely located from the physical server 105. The immediate recovery process transfers only a minimal amount of data across the network 205. To minimize the network traffic, only the backup data for the application data is transferred across the network 205 to the remote backup system 220 and stored on a storage device 215. In order to be able to perform an immediate recovery, the replicated backup files on disk 215 are transferred into a standby virtual machine (VM) 260 on the external virtual server 225. This standby virtual machine 260 must have a version of an operating system that is compatible with the application being restored. A CPU 255 on the external virtual server 225 executes software that creates the standby VM 260 and communicates with the remote backup system 220.

In an embodiment of the present invention, an initial bootable image is created to boot the VM 160. The initial bootable image includes custom software that is not part of the software that executes or is stored on the physical server 105. The custom software is executed during the recovery process to setup and initialize a file system and then to restore the backed up files to the file system. When a recovery of the physical server 105 is required, the VM 160 is placed in “restore mode”. In the “restore mode”, the VM 160 boots the initial bootable image and executes the custom software from the image. The custom software creates a partition on the boot drive of the VM 160 and initializes it. The boot drive for the internal virtual server is the second storage device 145. The custom software then requests the backed up files for the physical server 105 and places them in the created partition. The backed up files may suitably include application files and in some cases operating system files. Once all the backed up files have been stored in the created partition on the second storage device 145, the VM 160 is switched to the “live mode”. In the “live mode”, the VM 160 reboots off of the created partition executing the backed up files. Executing the backed up files causes the VM 160 to perform the operations that were executing on the physical server 105.

In some cases, an audit of the backup files is performed to validate the backup files. When an audit is being performed, a snapshot is taken of the created partition on the second storage device 145. When the snapshot has been taken, the VM 160 switches from the “restore mode” to the “audit mode”. In the “audit mode”, the VM 160 reboots using files from the snapshot of the created partition but halts operation after the application has been successfully started. Recovery times are determined and the snapshot and the data stored on VM 160 are deleted.

The recovery method described above can be performed by the internal virtual server 150 or the external virtual server 115. The virtual servers 150, 115 can perform the recovery directly or by using the VMs 160, 175 of each server 150, 115. When the external virtual server 115 is used to perform the recovery of the physical server 105, the partition can either be created on a storage device local to the external virtual server 115 or on the second storage device 145.

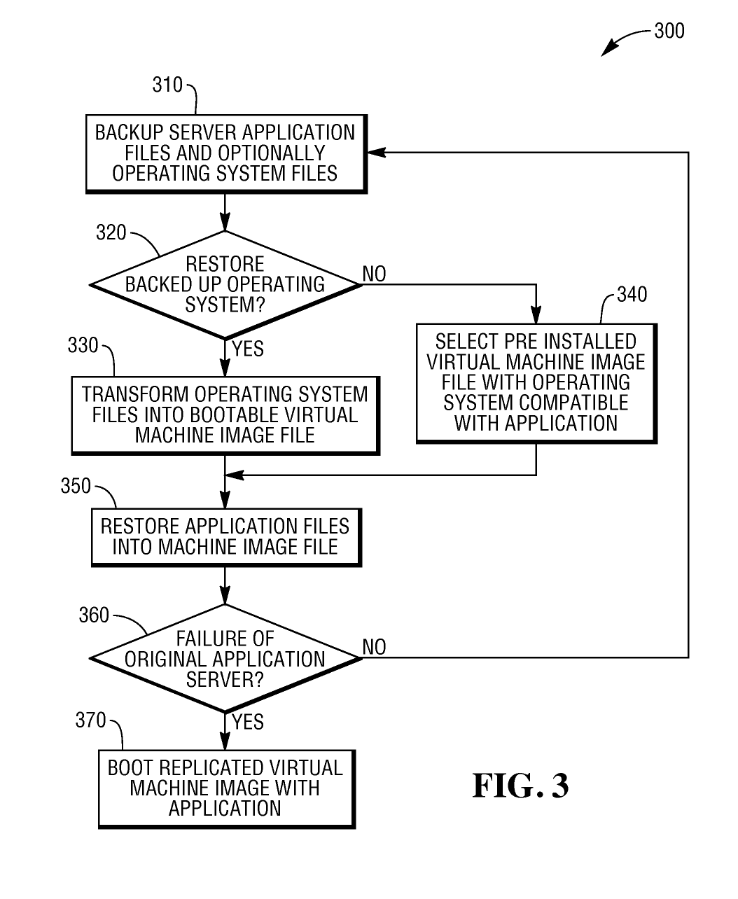

With reference to FIG. 3, there is provided a high-level flowchart illustrating a method of immediate recovery of a file level application backup with options for recovery of either the original operating system or a different operating system compatible with the application. The method performs an immediate recovery of the application files on the physical server 105 by executing backup application files on one of the virtual machines 160, 175. The method immediately accesses the application VM image from the second storage device 145 on the backup system 110 and transfers the data to either the virtual machine 160 of the internal virtual server 150 or to the virtual machine 175 of the external virtual server 115 for execution.

There are several methods for converting a physical server into a virtual server often referred to as physical to virtual (P2V). One such method is where a bootable disk image for the virtual server is used as a starting point, and the files from the backup or application are then transferred into that bootable partition or image file. This or a similar technique can be used to transform the application backup files stored on the first storage device 140 into a bootable virtual machine image stored on the second storage device 145.

It is important to note that, for the purposes of this invention, the goal is to present a recovered running application as fast as possible. Depending on the goals defined for the system, it may be desired to have the recovered application running on the identical operating system configuration as the source machine, or just to have the application running on a compatible version of the operating system.

At step 310, the backup system 110 receives application files and optionally operating system files from the physical server 105. To prepare a virtual machine image for recovery, a determination is made in step 320 whether to restore the original operating system or use a compatible operating system. If yes, then in step 330, the operating system files are transformed into a bootable virtual machine image. If no, then in step 340, a pre-existing bootable virtual machine image is chosen which includes a compatible operating system that will support execution of the application. Next in step 350, the application files are restored to a VM image stored on the second storage device 145. At this point, the VM image is ready to boot for immediate recovery. In step 360, check is made to determine if the physical server 105 has failed or is not available for normal use. If yes, control passes to step 370 for immediate recovery where the VM image is transferred into the VM 160 and executed. In some embodiments, the VM image is transferred to the VM 175 of the external virtual server 115 or the VM 260 of the remote external virtual server 225. If no, control passes back to step 310 and the backup system 110 will continue to receive updates to the application files.

Although the present invention has been described with particular reference to certain preferred embodiments thereof, variations and modifications of the present invention can be effected within the spirit and scope of the following claims.

What is claimed is:

1. A computer implemented method performed by a backup computer for backing up and restoring an application executing on another computer to quickly recover the application, the method comprising:
creating a virtual machine image for the application where the virtual machine image can be immediately accessed to implement a recovery of the application;
receiving files from a computer system executing the application;
transforming the received files to the format of the virtual machine image; and
updating the virtual machine image with the transformed received files.

2. The method of claim 1, further comprising:
receiving from an external computer a request to read data from the virtual machine image; and
transmitting the requested data from the virtual machine image to the external computer.

3. The method of claim 1, further comprising:
executing a virtual server where the virtual execution environment created by the virtual server is compatible with the execution environment the application executes in.

4. The method of claim 3, further comprising:
receiving from the virtual server executing on the backup computer a request to read data from the virtual machine image; and
transferring the requested data from the virtual machine image to the virtual server.

5. The method of claim 1, wherein creating the virtual machine image includes storing a default bootable operating system within the virtual machine image where the operating system is compatible with the operating system executing the application and wherein the files received from the computer system executing the application are related to the application.

6. The method of claim 1, wherein receiving files from the computer system executing the application includes receiving operating system and application files.

7. The method of claim 1, further comprising:
transmitting the virtual machine image to a virtual machine on a remote external virtual server.

8. The method of claim 7, wherein the Internet is used to transmit the virtual machine image to the remote external virtual server.

9. The method of claim 1, further comprising:
receiving a command to recover the application; and
transmitting, in response to the command to recover the application, the virtual machine image to a virtual machine adapted to execute the virtual machine image.

10. The method of claim 1, wherein the virtual machine image is a bootable machine image that can be executed by a virtual machine.

11. A backup computer comprising:
a memory including computer instructions that implement the functions of the backup computer when executed; and
a processor in communication with the memory where when the processor executes the computer instructions the computer instructions cause the processor to perform the following steps:
create a virtual machine image for an application executing on a first computer where the virtual machine image can be immediately accessed to implement a recovery of the application;
receive modified files from the first computer system executing the application;
transform the received files to the virtual machine image format; and
update the virtual machine image with the transformed received files.

12. The backup computer of claim 11, where the processor further performs the following step:
implement a virtual machine adapted to execute the virtual machine image.

13. The backup computer of claim 12, where the processor further performs the following step:
receive a command to recover the application.

14. The backup computer of claim 13, where the processor further performs the following step:
transmit in response to the command to recover the application the virtual machine image to the virtual machine implemented on the backup computer.

15. The backup computer of claim 11, where the processor further performs the following steps:
receive a command to recover the application; and
transmit, in response to the command to recover the application, the virtual machine image to a virtual machine implemented on a remote second computer.

16. The backup computer of claim 11, where the processor further performs the following steps:
receive from a second computer a request to read data from the virtual machine image where the second computer is adapted to implement a virtual machine that executes the virtual machine image; and
transmit the requested data from the virtual machine image to the second computer.

17. The backup computer of claim 11, where the processor further performs the following steps:
receive a request to read data from the virtual machine image from a virtual server implemented on the backup computer; and
transfer the requested data from the virtual machine image to the virtual server.

18. The backup computer of claim 11, wherein the virtual machine image includes a bootable operating system.

19. The backup computer of claim 11, wherein the virtual machine image only includes application files and data.

20. A computer implemented method performed by a first computer to recover computer operations previously performed on a second computer, the method comprising:
booting and executing an initial bootable image;
creating a partition on a local storage device;
receiving backed up files of the second computer;
storing the received backed up files in the created partition; and
rebooting and executing the backed up files stored in the created partition to perform the computer operations previously preformed on the second computer.
